(19) United States
(12) Patent Application Publication
(10) Pub. No.: US 2011/0299183 A1
(43) Pub. Date: Dec. 8, 2011

(54) Bonding technique to minimize distortion on a deformable mirror

(75) Inventors: Justin Dennis Mansell, Albuquerque, NM (US); Brian G. Henderson, Albuquerque, NM (US)

(73) Assignee: Justin D. Mansell, Albuquerque, NM (US)

(21) Appl. No.: 12/802,415

(22) Filed: Jun. 5, 2010

(51) Int. Cl. G02B 7/182

(52) U.S. Cl. 359/849

(57) ABSTRACT

This invention relates to a plate-type deformable mirror with discrete contacts between the faceplate and the actuators.

### REFERENCES CITED

U.S. Patent Documents

| Pat. No. | Date Issued | Inventor | U.S. Class |
|---|---|---|---|
| 3,904,274 | Sep. 9, 1975 | Feinleib et al. | 350/161 |
| 4,657,358 | Apr. 14, 1987 | Anthony et al. | 350/610 |
| 4,674,848 | Jun. 23, 1987 | Aldrich et al. | 350/610 |
| 5,619,059 | Apr. 8, 1997 | Li et al. | 257/431 |
| 6,108,121 | Aug. 22, 2000 | Mansell et al. | 359/291 |

### OTHER PUBLICATIONS

MANSELL et al., “Development of a Deformable Mirror for High-Power Lasers”, SPIE's Mirror Technology Days, Aug. 1, 2007 (Presentation Only).
MANSELL et al., “Novel Plate-Type Deformable Mirrors and Adaptive Optics Systems for High Power Lasers”, DEPS Directed Energy Systems Symposium, Apr. 8, 2009, (Presentation Only). (http://www.deps.org/DEPSpages/graphics/DEsysSymp09Program.pdf)
YODER, Paul R., Mounting Optics in Optical Instruments, 2nd Edition, SPIE Press Book (4 Aug. 2008), ISBN: 9780819471291.

### DESCRIPTION

1. Field of the Invention

This invention relates generally to the field of adaptive optics, and in particular to a plate-type deformable mirror suitable for use in a wide range of adaptive optics applications.

2. Background of the Invention

Adaptive optics is a technique for controlling the spatial phase of light that has been under development for several decades. In a general adaptive optics system, light is reflected from a deformable mirror and a small fraction is split off to illuminate a sensor. The sensor provides feedback to a control computer that adjusts the deformable mirror to change some property of the beam of light. Astronomers have used adaptive optics systems to remove the distortions induced by the atmosphere and achieve higher quality images from large telescopes. Adaptive optics systems have also been used on lasers to improve the beam quality and to shape the intensity profile.

For many years, plate-type deformable mirrors have been favored for both imaging and laser applications. U.S. Pat. No. 3,904,274 describes one of the first embodiments of a plate-type deformable mirror in which a thin flexible plate is attached to an array of piezoelectric actuators. U.S. Pat. Nos. 4,657,358 and 4,674,848 both describe an important variation of the plate-type deformable mirror in which the mirror surface is cooled for high power laser operation. In the past, cooling was necessary on these deformable mirrors because the even the best coatings had significant absorption. The heating of the deformable mirror caused warping of the mirror surface, a change in the response of the actuators to voltage, and exposed the device to potential damage, primarily at the sites where the actuators were bonded to the face sheet.

Plate-type deformable mirrors have only changed slightly in the more recent years. Today, these mirrors typically consist of lead manganese niobate (PMN) actuators to reduce the actuator hysteresis and reduce the operating voltage. They also use specially design plates with sculpted cross-sections so that the actuators attach to stiffer pillars that extend down from the back of the flexible plate.

There has been some work in recent years on applying micromachining technology to the fabrication of deformable mirrors. In U.S. Pat. No. 5,619,059, Li et al. describe a deformable mirror device with a multi-layer dielectric coating over sections of the mirror surface. U.S. Pat. No. 6,108,121 describes a continuous surface MEMS deformable mirror with a high reflectivity coating. While the modifications described in these patents make it possible for the MEMS mirrors to be applied to some high-power lasers, they have not demonstrated applicability to the lasers being considered for high-power laser weapons.

As laser power and system design power density has increased, traditional plate-type deformable mirrors have proved to be less effective. The PMN actuators change their response to voltage by about 3% per degree Celsius, so any significant heating causes the actuator response to vary. The most commonly used deformable mirror fabrication technique requires the actuators to be bonded to the sculpted faceplate before the faceplate is polished and coated. Many of the best coating techniques used today for high-power laser applications, like Ion-Beam Sputtering (IBS), are deposited with a significant amount of coating stress. When a traditional deformable mirror is coated using these high-stress coating techniques, the resulting mirror surface can be so significantly warped that the mirror surface is of very limited utility.

Mansell recently presented a modification to an older deformable mirror fabrication technique leveraging an older coating technique in an attempt to increase mirror reflectivity in 2007 (MANSELL et al., “Development of a Deformable Mirror for High-Power Lasers”, SPIE's Mirror Technology Days, Aug. 1, 2007). This presentation showed a device with lead zirconate titanate (PZT) actuators instead of the traditional PMN actuators because of the large reduction in voltage response variation with respect to temperature. In his presentation, Dr. Mansell described two different deformable mirrors. One deformable mirror was coated on only one surface. The second deformable mirror had a high reflectivity coating applied to both surfaces of the faceplate before the faceplate was bonded to the actuators. The deformable mirror coated on both surfaces exhibited less laser-illumination-induced distortion, but the technique was risky because the faceplate with a coating on both surfaces effectively created an optical etalon. In the right circumstances (certain angles of incidence, certain faceplate thicknesses relative to the wavelength, etc.), the effective reflectivity of the faceplate etalon can decrease dramatically causing much of the laser light to be transmitted through the faceplate to the underlying structure and causing damage to the deformable mirror. Despite the potential danger of the etalon transmission, the deformable mirror was a success with all of the actuators of both mirrors firing and a very low thermally-induced distortion.

In subsequent work, MANSELL et al. demonstrated the ability to put two different coatings on the two surfaces of the plate to both compensate stress and achieve high-power operation (MANSELL et al., “Novel Plate-Type Deformable Mirrors and Adaptive Optics Systems for High Power Lasers”, DEPS Directed Energy Systems Symposium, Apr. 8, 2009 and Provisional Patent Application Filed Sep. 12, 2008). Unfortunately, the use of the double-side coated plate-type DM makes the practice of polishing the faceplate after the actuators are bonded to the surface difficult.

One challenge with using a plate with coatings on both surfaces is that the deformable mirror faceplate needs to be bonded to actuators after the coatings have been applied, thus eliminating the possibility of polishing out any bond-induced distortion without removing the coating.

### OBJECTS AND ADVANTAGES OF THE INVENTION

The primary object of this invention is to enable the bonding of actuators at discrete points to a deformable mirror faceplate such that the bonding stress is minimized and the faceplate surface distortion is minimized.

### SUMMARY OF THE INVENTION

In the manufacture of a typical plate-type deformable mirror, actuators must be put in contact with a faceplate. In the process under consideration here, the faceplate is manufactured and coated prior to the bonding to actuators. Bonding can take place with a variety of methods, but in the preferred process we describe here, we use epoxy to attach the top of the actuators to the faceplate. We have found through experimentation that the majority of the faceplate distortion is induced when epoxy makes a connection from the sides of the actuator to the faceplate. This effect typically occurs when epoxy overflows from the top of the actuator to the sides. This bond is typically referred to as a fillet (YODER, Paul R., Mounting Optics in Optical Instruments, 2nd Edition, SPIE Press Book (4 Aug. 2008), ISBN: 9780819471291.). To verify that this fillet effect was responsible for the bond-induced distortion, we manufactured a prototype deformable mirror with just a few actuators and allowed the fillet effect to occur. We were easily able to see the bond-induced distortion on an optical interferometer. Then we carefully used a sharp steel blade to scrape away the majority of the epoxy in the fillet after it had cured and found that the bond-induced distortion was greatly reduced.

We have found that the literature cites volume control as the primary method of suppressing fillets. Unfortunately, volume control over the small actuator-to-faceplate bonds is extremely difficult, so an alternative solution was sought. Furthermore, the amount of epoxy varies from actuator to actuator because the faceplate is typically not perfectly flat and the surface formed by the actuator tops is not perfectly flat. The epoxy must bridge this gap.

We invented a solution in which the fillet bond force vector is broken so that it cannot induce distortion onto the deformable mirror faceplate. We present here different embodiments of this invention.

In the preferred embodiment, we apply a thin piece of tape cut into a square with a square section cut from the center that is smaller than the actuator tops to form a frame shape at the desired contact point of each of the actuators. Then a precise amount of epoxy is used to fill the center of the tape frame. Since the tape is thicker than most natural epoxy bonds, conventional pipetters can be used for this dosing. Finally, the actuators are brought in contact with the tape such that the hole in the tape frame is on the top of the actuator. Epoxy that overflows from the center of the frame can still form a fillet between the side of the actuators and the tape, but the tape to faceplate bond is weak enough to provide flexibility and greatly reduce fillet-induced distortions.

An alternative embodiment involves replacing the tape with an alternative flexible material like photoresist. Photoresist can be deposited and patterned into the same frame shapes using conventional lithographic techniques. Then the same process described above can be used to attach the actuators. As a final optional step, the photoresist can be removed after the epoxy has cured with a solvent like acetone.

In one more alternative embodiment, the sides of the actuators themselves are coated with a material to inhibit adhesion of the epoxy. Some such materials include silicone rubber, Teflon, and photoresist, which can be dissolved after the manufacture.

In this description, we referred to bonding the actuators to the faceplate, but the techniques described here are equally applicable when an interface material exists between the actuator tip and the faceplate.

A wide variety of different actuators can be used to warp the faceplate. In the preferred embodiment, we use PZT actuators. Other actuation methods include electrostricitive, magnetostrictive, MEMS, hydrostatic (fluid pressure), electrostatic, and other pizeoelectric actuators.

A wide variety of different bonding mechanisms can be used in this invention. We use epoxy in the preferred embodiment, but there are many different liquid adhesives that can be used as alternatives including acrylic bonding.

### BRIEF SUMMARY OF THE FIGURES

FIG. 1 shows the architecture of a simple plate-type deformable mirror.

FIG. 2 shows the effect of a fillet on the surface of a plate-type deformable mirror.

FIG. 3 shows the bottom of a faceplate with frames of material for interrupting the fillet bond.

FIG. 4 shows a cross-section of the actuator to faceplate interface of a plate-type deformable mirror manufactured using the non-removed material embodiment of the intention.

FIG. 5 shows a cross-sectional view of the first step in the removable material embodiment of the invention in which the material has been applied to the faceplate.

FIG. 6 shows a cross-sectional view of the second step in the removable material embodiment of the invention in which the actuator has been bonded to the faceplate.

FIG. 7 shows a cross-sectional view of the optional final step in the removable material embodiment of the invention in which the masking material has been removed from the faceplate.

FIG. 8 shows a cross-sectional view of the actuator to faceplate interface of a plate-type deformable mirror that has had the fillet bond interrupted by coating the actuator with a non-adhesive material on the sides of the actuator.

### DETAILED DESCRIPTION

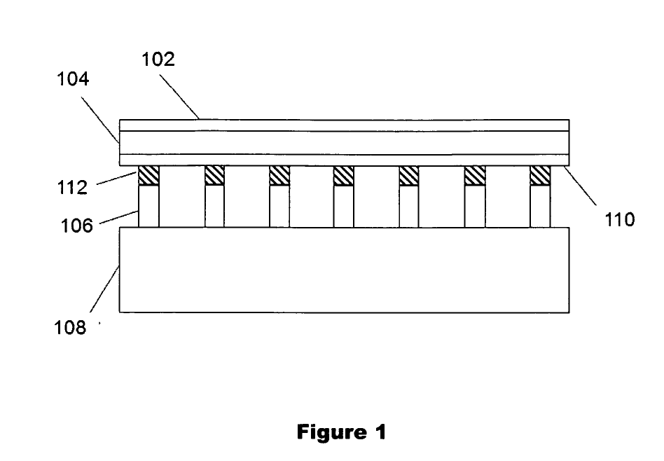

FIG. 1 shows a cross-sectional image of the basic architecture of a plate-type deformable mirror. A faceplate 104 with optional coatings on the top 102 for reflectivity and on the bottom 110 for stress compensation is bonded to an array of actuators 106 that are bonded to a base plate 108. Many plate-type DMs have an optional piece 112 that is an interface between the actuators and the faceplate for mechanical and thermal expansion reasons. The interface is typically made of material with the same coefficient of thermal expansion as the faceplate so that temperature changes do not cause distortion. Furthermore the interface piece provides a buffer region to allow any non-uniform distortion in the actuator to not print into the faceplate. Throughout the rest of this description we will refer to the interface between an actuator and the faceplate, but this interface piece could be inserted as well.

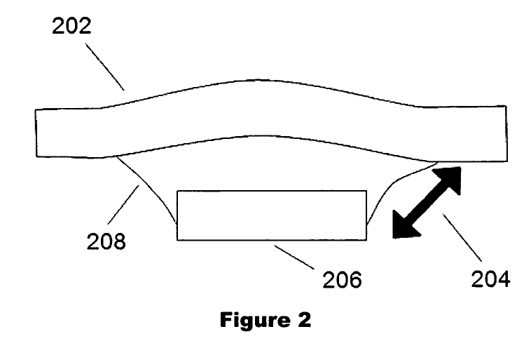

FIG. 2 illustrates in cross-section the typical problem with overflow from a liquid bonding material 208 like epoxy between the actuator 206 (or interface piece) and the faceplate 202, which is shown here without coatings. As the liquid bond cures or the temperature changes a force 204 develops between the faceplate and the side of the actuators due to the overflowed material fillet. This force causes significant distortion in the faceplate.

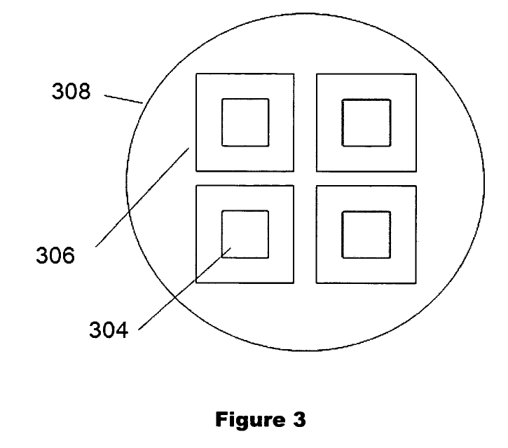

FIG. 3 shows a bottom view of a circular faceplate 308 with square frames of tape 306 that have been filled with a liquid bonding agent 304. This is the condition of the faceplate we create just before the application of the actuators or interface material.

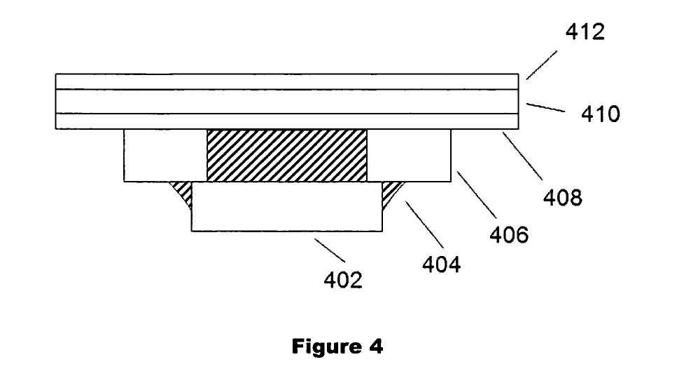

FIG. 4 shows a cross section of the assembled interface between the faceplate and the actuator or interface piece. The faceplate 410 is shown coated with a top coating 412, which is typically for enhanced reflectivity, and a bottom coating 408, which is again typically used for stress compensation of the top coating. These coatings can be used for other things like reflectivity at different wavelengths. The tape frame 406 provides both spacing and a place for the liquid bond to overflow onto when the actuator or interface 402 is placed in contact with the tape. The overflowed liquid bonding agent then bonds from the side of the actuator to the surface of the tape instead of to the coated faceplate surface. In this embodiment, the tape is bound to the faceplate with a flexible bonding agent, like silicone, so that the effect of the fillet force between the side of the actuator and the faceplate is reduced thereby minimizing the distortion induced by bonding.

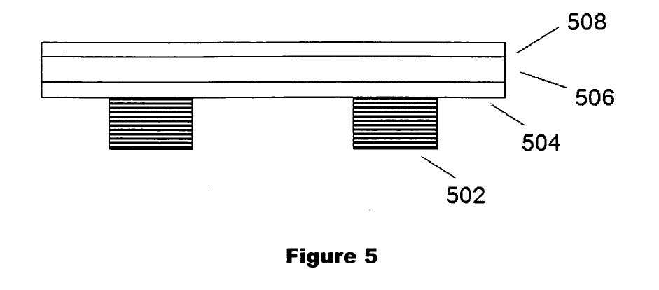

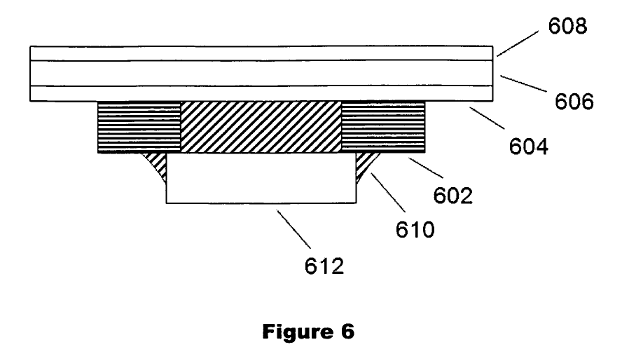

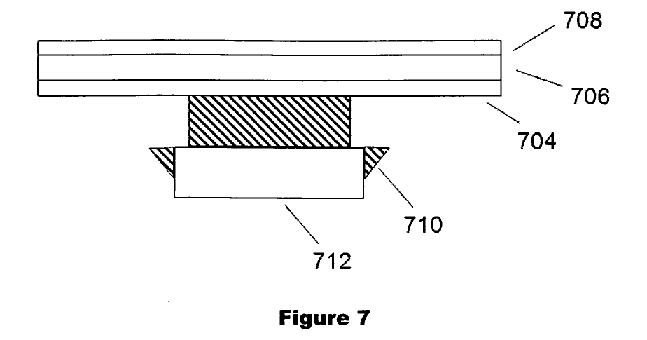

FIG. 5, FIG. 6, and FIG. 7 show cross-sectional images illustrating three steps in the use of a dissolvable mask for implementing the same technique. FIG. 5 shows the faceplate 506 with the optional top coating 508 (typically for enhanced reflectivity) and bottom coating 504 (typically for stress compensation) and the dissolvable mask 502 after it has been patterned into a frame shape. FIG. 6 again shows the faceplate 606, top coating 608, bottom coating 604, dissolvable mask 602, liquid bonding agent 610, and the top of the actuator or actuator interface 612. This cross-sectional image looks similar to that shown in FIG. 4, except the tape has been replaced with a dissolvable mask material. FIG. 7 shows the cross-section of the actuator to faceplate interface after the mask material has been dissolved. In FIG. 7, the faceplate 706 is depicted with a top coating 708 and a bottom coating 704, cured liquid bonding agent 710, and the top of the actuator or interface 712. The advantage of this technique is that the fillet formed due to overflow of the liquid bonding agent is no longer forming a direct connection to the faceplate, thereby eliminating the distortion induced by the bond force between the side of the actuator or interface and the faceplate.

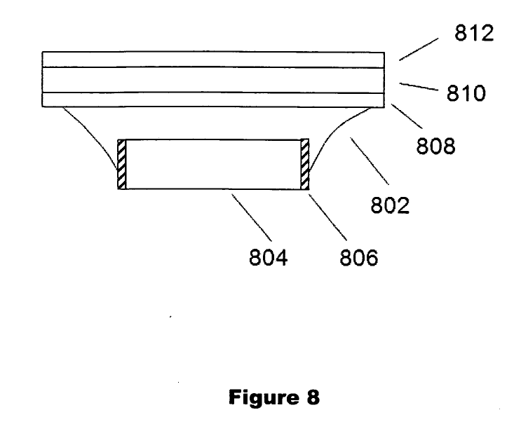

FIG. 8 shows a cross-sectional view of the actuator assembly to faceplate interface in which the actuator assembly 804 is attached to the faceplate 810 with coatings on the top 812 and bottom 808 with a liquid bonding agent 802. The liquid bonding agent that overflows from the interface to the sides of the actuator assembly is prevented from adhering with a coating 806 on the actuator assembly sides. Practically it may not be possible to avoid the coating from covering a section of the top of the actuator assembly, but if limited to a small region on the edges of the top of the assembly, this will not be problematic. The preferred coating would be silicone because of its know lack of adhesion to epoxy, but other materials like Teflon or other polymers might be equally effective.

What is claimed is:

1. An actuated mirror comprising
a. a thin flexible faceplate of solid material,
b. actuators with their top face bonded to that faceplate with a liquid bonding agent such that the liquid bonding agent is unable to form a strong bond between the side of the actuators and the faceplate, and
c. a stiff base-plate bonded to the bottom face of the actuators.

2. The mirror of claim 1 such that the liquid bonding agent is epoxy.

3. The mirror of claim 1 where tape with flexible adhesive is attached to the faceplate to limit the bond area between the actuator top and the faceplate.

4. The mirror of claim 3 where the tape is a silicone adhesive with a Teflon backer.

5. The mirror of claim 3 where the tape on the faceplate additionally acts to weaken the bond strength of the liquid bonding agent between the faceplate and the side of the actuator.

6. The mirror of claim 1 where a removable material is used to limit the contact area of the liquid bonding agent to an area between the faceplate surface and the actuator top surface and prevent any overflowed bonding agent from forming a bond between the side of the actuator and the faceplate surface by removing this material after the bonding has occurred.

7. The mirror of claim 6 where the removable material is photoresist.

8. The mirror of claim 1 where the sides of the actuator are coated with a material to weaken the bond between the sides of the actuator and the faceplate.

9. The mirror of claim 8 where the sides of the actuator are coated with silicone.
